(19) United States
(12) Patent Application Publication
(10) Pub. No.: US 2013/0117272 A1
(43) Pub. Date: May 9, 2013

(54) SYSTEMS AND METHODS FOR HANDLING ATTRIBUTES AND INTERVALS OF BIG DATA

(71) Applicants: Roger Barga, Bellevue, WA (US); Alexander Sasha Stojanovic, Los Gatos, CA (US); Henricus Johannes Maria Meijer, Mercer Island, WA (US); Carl Carter-Schwendler, Redmond, WA (US); Michael Isard, San Francisco, CA (US)

(72) Inventors: Roger Barga, Bellevue, WA (US); Alexander Sasha Stojanovic, Los Gatos, CA (US); Henricus Johannes Maria Meijer, Mercer Island, WA (US); Carl Carter-Schwendler, Redmond, WA (US); Michael Isard, San Francisco, CA (US)

(73) Assignee: MICROSOFT CORPORATION, Redmond, WA (US)

(21) Appl. No.: 13/288,950

(22) Filed: Nov. 3, 2011

(51) Int. Cl. G06F 17/30

(52) U.S. Cl. 707/741; 707/736; 707/748; 707/E17.002

(57) ABSTRACT

Data management techniques are provided for handling of big data. A data management process can account for attributes of data by analyzing or interpreting the data, assigning intervals to the attributes based on the data, and effectuating policies, based on the attributes and intervals, that facilitate data management. In addition, the data management process can determine relations among data in a data collection and generate and store approximate results concerning the data based on the attributes, intervals, and the policies.

### TECHNICAL FIELD

The subject disclosure relates to handling big data and more specifically to systems and methods for handling attributes and intervals of big data.

### BACKGROUND

Traditionally, time-stamping of data at any granularity that makes sense for a given context essentially treats time as flat information. For example, data that is valid as of 100 million years ago is considered as being equally important to data that is valid as of 10 minutes ago. However, when a data set gets extremely large, (e.g., big data) the flat representation of time implies flat processing of time. This flat processing of time can be inefficient particularly where temporal relationships are significant (e.g., as opposed to absolute time or relative time differences).

In this regard, as time passes, initially, data associated with time information helps the data becomes more structured as the time information informs subsequent queries of the data. For example, historical salary information for an individual or a group of individuals can be queried as to the salary information on a particular date or date range. However, at a certain point, data becomes so large that the addition of this time information can create a sea of distracting information, much of which becomes irrelevant over time, making the data less structured over time. In a further example, as the data ages, the facts that employees leave a firm or receive pay increases make older data irrelevant or misleading as respects queries concerning current salary information.

For instance, temporal databases may associate data with a timestamp and/or a validity time interval. Thus, timestamps and/or validity time intervals can be employed, for instance, in point in time queries (e.g., determining an employee's salary at a particular point in time, average employee salary at a particular point in time, etc.). However, such timestamps and/or validity time intervals can be considered fixed or hard values in relation to associated data. That is, such timestamps and/or validity time intervals do not change until the data is updated.

As a result, timestamps and/or validity time intervals are typically employed for point in time queries, where the queries are limited in their usefulness, because they are only valid for the specific information queried at the given time and over the fixed or hard values of timestamp and/or a validity time interval. The timestamps and/or validity time intervals must be updated to account for updates to the relevant data and queries rely on the fixed or hard values of timestamp and/or a validity time interval.

It is clear that as the collection of data becomes so large, the associated timestamps and/or validity time intervals may not adequately account for changes in the data for a particular query, the proper aging or consideration of the data in the collection, and/or the relative importance of recent additions to the data collection. That is, the loss of structure in the collection of data over time can decrease the utility of the collection, can require updated queries to account for recent changes, and fail to account for the appearance of peripherally related data that may bear on the validity of the queries unless specifically queried, and so on.

The above-described deficiencies in the handling of big data are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In an example embodiment, a data management method comprises analyzing data received by a computing device to determine one or more attributes of the data, assigning an interval to the one or more attributes based on the analyzing, and associating a policy with the one or more attributes or the interval to facilitate management of the data. Attributes and/or intervals can be used to effect a data aging policy, a data retention policy, a data organization policy, a data ranking policy, as well as other functions of data management. In addition, the data management method can further comprise determining one or more relations to other data and generating and/or storing an approximate result concerning the data based on the one or more attributes, the interval, and/or the policy.

In another example embodiment, a computing device comprises an analysis component configured to interpret data received by the computing device to determine one or more previously unknown or undetermined attributes of the data to create one or more attributes of the data, an interval component configured to assign an interval to or associate the interval with the one or more attributes based on the one or more attributes of the data, and a policy component configured to associate a policy with the one or more attributes or the interval to facilitate management of the data.

In another example embodiment, a computer-readable storage medium comprises computer-readable instructions that, in response to execution, cause a computing device to perform operations, comprising interpreting data received by the computing device to determine one or more previously unknown or undetermined attributes of the data to create one or more attributes of the data and associating an interval to the one or more attributes based on the interpreting. The operations further comprise determining a policy related to one or more attributes or the interval to facilitate management of the data.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates a flow diagram illustrating an example process employing vector clocks as an aid in further describing various embodiments;

FIG. 2 is a block diagram illustrating a non-limiting operating environment suitable for incorporation of various embodiments;

FIG. 3 is a block diagram illustrating exemplary systems according to various embodiments that can employ attributes, intervals, and/or policies in the handling of big data;

FIG. 4 is a block diagram illustrating exemplary systems, according to further non-limiting aspects, that facilitate generating approximate results, creating statistical descriptions or summaries of data, informing the sampling of data in a data collection, adding weighting functions to data, and/or down-weighting of aged data, etc., in the handling of big data;

FIG. 5 is a block diagram illustrating exemplary systems, according to further non-limiting aspects;

FIG. 6 is a flow diagram illustrating a non-limiting process for data management in an embodiment;

FIG. 7 is a block diagram representing exemplary non-limiting networked environments in which various embodiments described herein can be implemented; and

FIG. 8 is a block diagram representing an exemplary non-limiting computing system or operating environment in which one or more aspects of various embodiments described herein can be implemented.

### DETAILED DESCRIPTION

### Overview

As indicated in the background, when a data set gets extremely large, (e.g., big data) the conventional flat representation of time implies flat processing of time, which can, due to the passage of time the loss of structure in the collection of data can decrease the utility of the collection. As the collection of data becomes so large, timestamps and/or validity time intervals associated with the data may not adequately account for changes in the data or relative importance of recent data or peripherally related developments for a particular query.

In a non-limiting example regarding the causality between two events, time and space are related by change in distance over a relevant time interval (e.g., velocity or speed). For instance, regarding event horizons in a computer network, the possibility of two events being causally connected to one another can be understood to be limited by the separation of the two events in space (e.g., in terms of physical network distance) and time between the two events, where the event horizon is limited by the speed of light. In a non-limiting fraud detection example in the case of the physical credit card being used, the event horizon for which to judge the causality of two events can be limited by an estimated speed of an airplane, speed of a car, etc. Thus, by comparing spatial and/or temporal information, associated with two events, with an event horizon, inferences can be drawn regarding possibility, causality, probability, and so on.

Thus, the issue of whether or not two data points or events could be causal or possible can be determined, according to various aspects as described herein, based on attributes of the data (e.g., temporal and/or spatial information, etc.). That is, it may be impossible, given a particular sequence of temporal and/or spatial information related to two data points or events. For instance, it might be of interest whether, for a collection of data points or events (e.g., “A,” “B,” “C,” “D,” “E,” etc.), “A” leads to “E” through a suspected causal chain “B,” “C,” and “D.” Perhaps the link to “B” is possible based on an analysis of the respective temporal and spatial information. But it might be that “C” is not possible from “B,” even though “D” is possible from “B.” The concern is that if you break the causal chain at anywhere between “A” and “D,” then there is no longer a possibility that “A” lead to “E.” Conventional solutions to this type of problem are typically special case scenarios where conditions based on preexisting hypotheses (e.g., a posteriori knowledge, observed data or events, etc.) are tested against available data or events. However, when data or events fall outside the assumptions built into the hypothesis, conventional hard-coded solutions can fail to produce a reliable answer.

For instance, in the fraud detection example of a physical credit card, the possibility of two data points or events being causally related can depend on the spatial and/or temporal information associated with the data or events and the relevant in horizon. Further adding to the problem, a data point or event that occurs earlier in time can become unreliable as the data point or event ages. For example, a credit card used in San Diego, Calif., and Houston, Tex., within a short time period relative to the relevant event horizon may have a strong causal connection indicating fraud. However, as the earlier data point or event ages, it may become completely possible that the later data point or event is a valid transaction due to travel by the cardholder (or at least the conclusion of fraud may be less reliable).

In a further non-limiting network traffic analysis example, if two or more network events occur within a short time period relative to the relevant event horizon, even if they have different originations, it may be inferred that there is a strong causal connection between the two or more network events indicating a coordinated attack on the network. Likewise, as the network event ages, it may become completely possible that the later network event is valid and benign network traffic.

While temporal databases my account for time information (e.g., timestamp and/or validity time intervals) they can be ill-equipped to address questions of causality. For instance, a temporal database is a database that can incorporate time aspects into the database, such as a temporal data model and a temporal version of Structured Query Language (SQL). For example, the temporal aspects can comprise a valid-time and a transaction-time (e.g., bitemporal data) or other time related data for data entering the database, where valid time can denote the time period during which a fact is true with respect to the real world, whereas transaction time can denote the time period during which a fact is stored in the database. As described above, this enables queries that show the state of the database at a given time (e.g., point in time queries).

For instance, while temporal databases may associate data with a timestamp and/or a validity time interval, such timestamps and/or validity time intervals do not change until the data is updated. As a result, timestamps and/or validity time intervals are typically employed for point in time queries, where the queries are limited in their usefulness, because they are only valid for the specific rigidly structured information queried at the given time and over the fixed or hard values of timestamp and/or a validity time interval. The timestamps and/or validity time intervals must be updated to account for updates to the relevant data, and queries rely on the fixed or hard values of timestamp and/or a validity time interval. However, the temporal database's focus on database state with respect to time leaves out the questions regarding spatial information, as this information is not relevant to the purpose of a temporal database, and data relationships are built-in to the database structure (e.g., employee John has a social security number (SSN), his SSN is associated with a position, a manager, a salary, an office location, and so on.

In addition, with any discussion of time and its effects on and analysis (e.g., causality, possibility, correlations, probability and so on, etc.), the question arises as to what notion of time will be attributed to data entering a system. That is, for data entering a system receiving a timestamp it must be determine what time to use (e.g., absolute time, database time, time at origin, time at destination, time recorded, time relative to an initial event, time difference, etc.). However, concerning time intervals and their use in subsequent analyses (e.g., causality, possibility, correlations, probability and so on, etc.) concerning two data points or events, time the time of one data point or event relative to another is typically employed.

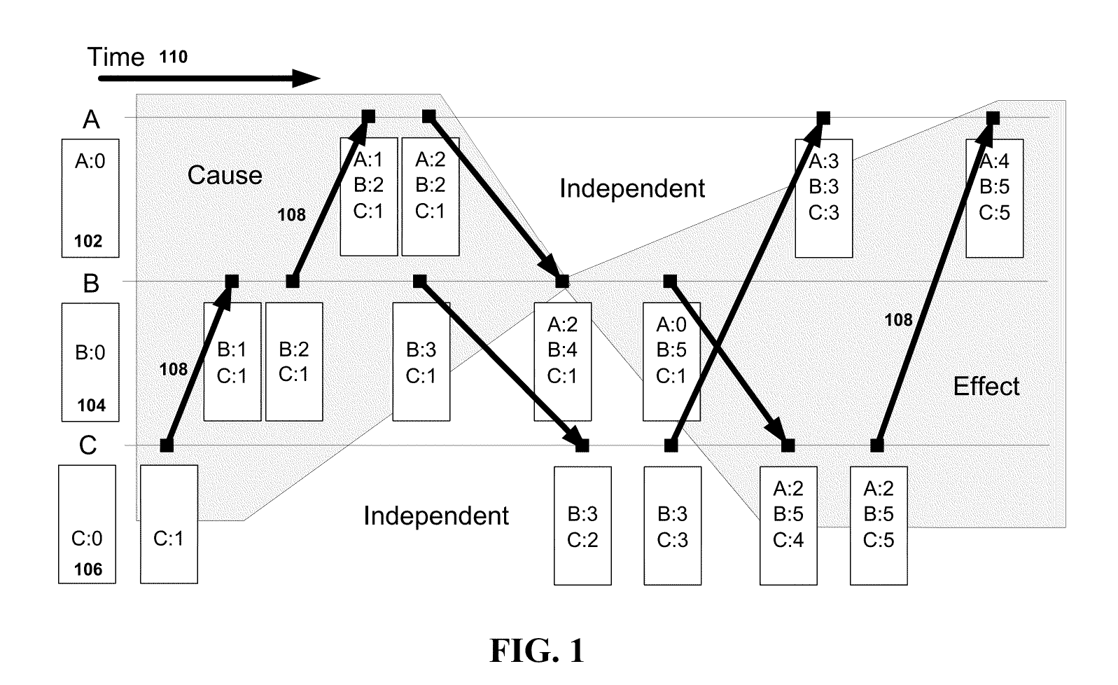

For instance, a vector clock is a system by which a number of independent agents can be keeping their own clocks, yet still be used for the purpose of analyses of relations between data or events. As a non-limiting example, a vector clock is an algorithm that facilitates generating a partial ordering of events in a distributed system and detecting causality violations. FIG. 1 illustrates a flow diagram illustrating an example process 100 employing vector clocks or processes “A” 102, “B” 104, and “C” 106 as an aid to further describing various embodiments. For example, initially all clocks are zero set to zero (e.g., A:0, B:0, C:0). Inter-process messages 108 can be sent that can comprise the state of the sending process's logical clock (e.g., A:2, B:3, C:5). Thus, a vector clock system can be understood as a system of N processes in an array/vector of N logical clocks, having one clock per process (e.g., “A” 102, “B” 104, and “C” 106).

In addition, a local “smallest possible values” copy of the global clock-array tracking time 110 can be kept in each process, with the following rules that facilitate clock updates. Each time a process (e.g., “A” 102, “B” 104, and “C” 106) experiences an internal event, it can increment its own logical clock in the vector by one (e.g., from A:0 to A:1, etc.). Each time a process prepares to send a message, it increments its own logical clock in the vector by one (e.g., from B:1 to B:2 for process “B” 104, etc.) and then sends its entire vector (e.g., the set of B:2 and C:1 for process “B” 104, etc.) along with the message being sent. Each time a process receives a message, it increments its own logical clock in the vector by one (e.g., from A:0 to A:1 for process “A” 102, etc.) and updates each element in its vector by taking the maximum of the value in its own vector clock and the value in the vector in the received message for every element (e.g., adds B:2 and for process “A” 102, etc.).

As a result, it can be seen that the various processes (e.g., “A” 102, “B” 104, and “C” 106), by keeping track of the relevant events related to the processes, can be used to facilitate analyses (e.g., causality, possibility, correlations, probability and so on, etc.), at least with respect to time aspects of causality and with regard to the limited subset of processes in the vector clock system. However, such vector clock systems can be limited in that, while the vector clock system can be used to determine a partial ordering of events in a distributed system and detecting causality violations, the set of events that can be considered is limited by the number of processes in the vector clock system, the processes each require significant resources even on a small scale, and operation in dynamic environments when the identities and number of processes are unknown can be prohibitive. For instance, referring to FIG. 1, it can be seen that the realms of cause and effect (shaded grey) of the various events of the processes (e.g., “A” 102, “B” 104, and “C” 106) can be limited based on the vector clock algorithm, where the independent realms indicate events outside the causal chain. In addition, as with temporal databases, there is no provision for analyses (e.g., causality, possibility, correlations, probability and so on, etc.) based on spatial information.

Accordingly, in various embodiments presented in the subject application, data can be treated as events that are temporal and/or spatial in nature. As illustrated above, the temporal impact (as well as the spatial and other impacts) of those data or events can depend on a user's intentions with the data or events and the type of analyses that are being performed or intended. For example, temporal information can be used both for reasoning (e.g., such as in temporal Bayesian networks for database organization of data or the analysis or the impact of the event, etc.) and for the organization of data (e.g., partitioning of data, aging of data, moving data out of a collection, etc.). As a further example, data or events such as a user indicating his or her car is broken or that somebody related to him has died have a temporal nature (as well as a spatial nature and/or other qualities) associated with these data or events. Thus, it can be understood that temporal information (as well as a spatial information and/or other qualities) or data can be treated as a first class citizen in data collections rather than as any ordinary data field.

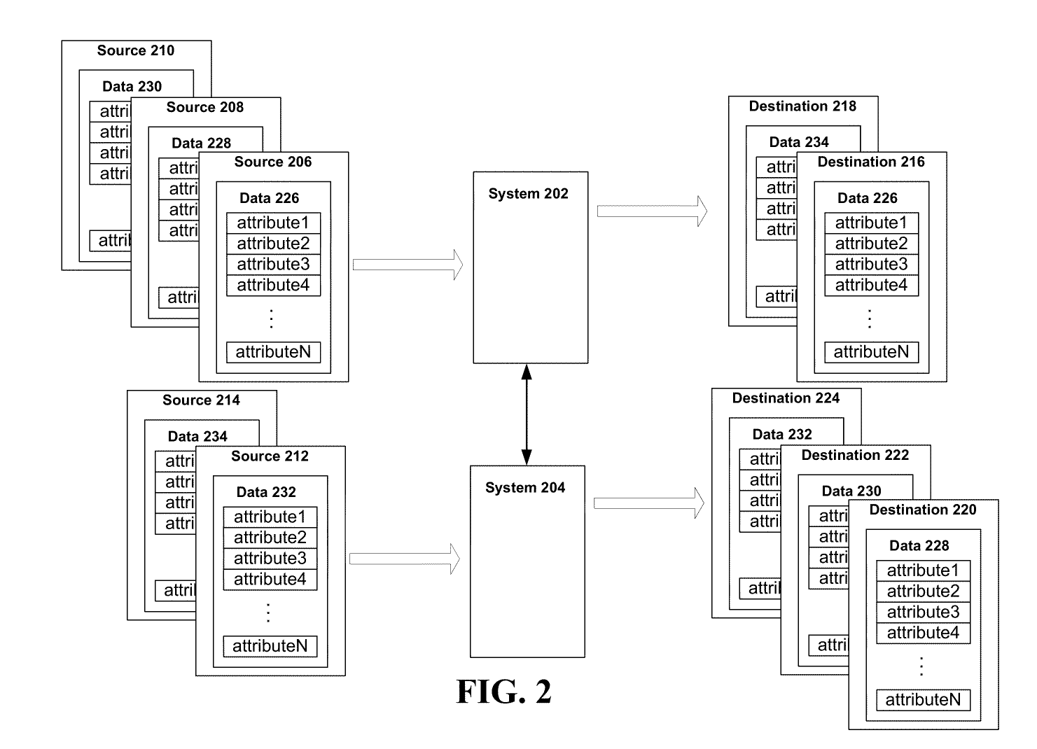

To these and related ends, FIG. 2 is a block diagram illustrating a non-limiting operating environment suitable for incorporation of various embodiments. The operating environment can comprise a number of computing systems 202, 204, as further described herein, configured to receive, from a number of sources (e.g., source 206, 208, 210, 212, and 214, etc.), data (e.g., data 226, 228, 230, 232, and 234, etc.). The system computing systems 202, 204, or portions thereof, can be mobile or fixed, local or remote, and/or distributed or standalone computing systems. The data can comprise any information that capable of being received by computing systems 202, 204, and can comprise information about which various attributes can be determined. The sources (e.g., source 206, 208, 210, 212, and 214, etc.) can comprise computing systems, as described herein, and can be automated or manual or any combination thereof. Note that while FIG. 2 indicates that the attributes can be known or associated with the data prior to receipt of the data by computing systems 202, 204, the attributes may not be known or associated with the data prior to being received by computing systems 202, 204.

For the purposes of this application, data (e.g., one or more or data 226, 228, 230, 232, and 234, etc.), prior to being received by computing systems 202, 204, can comprise one or more unknown or unassociated attributes that can be determined or associated with the data after receipt by computing systems 202, 204. For example, in various embodiments, attributes can comprise temporal or other information (e.g., spatial information and/or other qualities such as version, source, destination, one or more potential uses or analyses intended, probability or fact of a causal relation to another item or set of the data collection, etc.) about the data. In addition, the operating environment can comprise a number of destinations (e.g., destination 216, 218, 220, 222, and 224, etc.) configured to receive data (e.g., one or more or data 226, 228, 230, 232, and 234, etc.) from computing systems 202, 204. The destinations (e.g., destination 216, 218, 220, 222, and 224, etc.) can be computing systems, as described herein, and can be automated or manual or any combination thereof.

In conventional systems such as databases, file systems, and so on, as data is coming into the system, data is typically written to the system without regard to any potential uses or intended analyses that will be done with regard to the data. That is, the data is simply stored and perhaps assigned a timestamp, such as time created, and so on. As described above, temporal databases can assign a time interval and validity interval. However, consider the case of a user or automated system that is short on resources or pressed for time to get an answer regarding analysis of data in a data collection (e.g., one or more or data 226, 228, 230, 232, and 234, etc.). In this instance, the user (or automated) would be most efficient having the freshest and most relevant data already organized and placed in a container by a back-end storage system (e.g., destination 216, 218, 220, 222, and 224, etc.) so that he or she can do linear scans on the data collection, rather than having to first seek out the most relevant data and then performing the analysis.

Various non-limiting embodiments of the subject application provides exemplary systems (e.g., one or more of computing systems 202, 204, portions thereof, etc.) and methods that facilitate automatically performing various operations on data (e.g., analyses, interpretation, inference, assigning intervals, creating and associating policies, data organization, data retention, data collocation, creating indices, creating statistical or other summaries, and so on, etc.) by employing data attributes (e.g., temporal information, spatial information and/or other qualities such as version, source, destination, one or more potential uses or analyses intended, probability or fact of a causal relation to another item or set of the data collection, etc.) that are known, determined, inferred, and/or associated with the data as it comes into the system.

In a non-limiting social networking or collaboration example, friends or collaborators who are not collocated have different requirements regarding access to recent data than friends or collaborators who are separated by a greater distances, in different time zones, etc. Accordingly, various embodiments (e.g., one or more of computing systems 202, 204, portions thereof, etc.) enable the attachment of significance to data (e.g., policies associated with attributes and/or intervals that allow data in the past or a different location to be lower ranked based upon a data ranking policy such as personal preferences, the specification of a personal ranking system, weighting of historical data, etc.), which can facilitate weighting data so it can become less relevant to subsequent analyses, and so on. In a further non-limiting example, various embodiments can enable the attachment of temporal significance to data to facilitate weighting historical data as it ages so it can become less relevant to the query results, and so on. In further non-limiting examples, various embodiments can enable the attachment of spatial significance, as well as significance based on other attributes, to data to facilitate weighting data so it can become less relevant to the query results, and so on. As a result, loss of structure in the data collection due to the passage of time can be mitigated and the utility of the data collection can be maintained and improved.

Referring again to the determination of whether, for a collection of data points, “A” leads to “E” through a suspected causal chain “B,” “C,” and “D,” and the vector clocks illustration, it may be surmised on the basis of a vector clocks system that “A” can indeed lead to “E” through a suspected causal chain “B,” “C,” and “D,” given the state of the vector clocks system at a particular time. However, as new data or events enter the world of events to be considered, the vector clocks system may fail to recognize the causal significance of the new data or events. For example, assume that a supervening event “C′” occurs outside of the vector clocks system that either reinforces or casts doubt on the causal link between “C” and “D” (e.g., based on one or more of temporal information, spatial information and/or other qualities such as version, source, destination, one or more potential uses or analyses intended, probability or fact of a causal relation to another item or set of the data collection, etc.).

Moreover, while a vector clocks system can facilitate generating a partial ordering of events in a distributed system and detecting causality violations for a set of data or events that are occurring relatively concurrently, vectors clocks may fail to account for the changes in the impact of one or more data or events as the data in a data collection ages. That is, the vector clocks system fails to account how the impact of the data or events fade out according to a set definition (e.g., due to the passage of time, as a result of subsequent conflicting data, etc.)

As a result, the vector clocks system can be unable to reflect the impact of the new data or events or how old data or events can or should be aged out of the data collection. However, according to a non-limiting aspect, exemplary embodiments can facilitate assigning probabilities to the individual event horizons or individual steps (e.g., from “A” to “B,” from “B” to “C,” and so on, etc.), such that a probability can be determined for the overall event horizon for the suspected causal chain between “A” to “E” to enable ascertaining a more granular understanding of the possibility or probability of causality of the series of data or events. In a further non-limiting aspect, exemplary embodiments can facilitate specifying how the impact of the data or events fade out according to a set definition to facilitate ascertaining a more flexible understanding of the possibility or probability of causality of the series of data or events.

As a non-limiting example, intervals (e.g., temporal intervals, spatial intervals, etc.) can be assigned to data to aid in the aging of data, to facilitate exploiting temporal causalities for more efficient query of large sets of data. In a particular non-limiting embodiment, a mechanism employing a vector clock system or similar mechanisms can be employed to facilitate a linear ordering in time for two or more data or events. Accordingly, inferences can be generated from this mechanism's notion of time (e.g., vector clock time) rather than clock time, in a non-limiting aspect.

Thus, in various non-limiting embodiments, an exemplary system can receive data, and as data comes in to the system, the data can be treated as events. For instance, exemplary systems can employ an interpretation or analysis phase, which can determine or compute one or more attributes about the data or events and can determine or compute and assign an interval (e.g., information determined via a vector clock or similar mechanism for assigning temporal information to the data, etc.), based on the analysis or interpretation phase, and which can be employed by exemplary systems (e.g., for data retention, for data organization, aging of data, attaching a relative significance or weighting factor to the data, etc.

Accordingly, in further non-limiting embodiments, exemplary systems can employ the one or more attributes and one or more assigned intervals for reasoning, analysis, inference, and other uses based on the data and the intervals. For example, in further non-limiting embodiments, policies affecting the use of the data can be determined, created, and/or associated with the data (e.g., based on the one or more attributes and one or more assigned intervals) as further described herein. In a non-limiting aspect, polices (e.g., policies associated with attributes and/or intervals that allow data in the past or a different location to be lower ranked based upon personal preferences, the specification of a personal ranking system, weighting of historical data, etc.) can facilitate weighting data so it can become less relevant to subsequent analyses, and so on. In another non-limiting aspect, policies can related to data storage, data organization, data retention, and so on or other functions concerning data and one or more potential uses or analyses intended for the data, etc.

Thus, referring again to FIG. 2, as data is received by exemplary systems (e.g., one or more of computing systems 202, 204, portions thereof, etc.) the systems and methods as described herein can facilitate automatically performing various operations on data (e.g., analyses, interpretation, inference, assigning intervals, creating and associating policies, data organization, data retention, data collocation, creating indices, creating statistical or other summaries, and so on, etc.) by employing data attributes (e.g., temporal information, spatial information and/or other qualities such as version, source, destination, one or more potential uses or analyses intended, probability or fact of a causal relation to another item or set of the data collection, etc.) that are known, determined, inferred, and/or associated with the data as it comes into the system.

As a non-limiting example, as data in a data collection (e.g., one or more or data 226, 228, 230, 232, and 234, etc.) is received at the one or more computing systems (e.g., one or more computing systems 202, 204, portions thereof, etc.), the one or more computing systems can dynamically analyze or interpret the data that comes in to the one or more computing systems, and as a result, attributes can be determined or associated with the data. Note that, while the data is described as coming into the one or more computing systems for the purposes of illustration, inferring the data is pushed into the system, it can be understood that the one or more computing systems can equally pull data from other systems (e.g., either as a result of a direct command to do so, autonomously, semi-autonomously, or otherwise based on inferences drawn by the one or more computing systems, etc.). In further non-limiting examples, the one or more one or more computing systems can also dynamically compute and/or assign one or more intervals to the data (e.g., based on the analyzing or interpreting, the one or more attributes known, determined, or associated with the data, etc.) and can create and/or associate one or more policies related to the one or more intervals dynamically computed and/or assigned to the data, as further described herein.

As a result, for data in the data collection (e.g., one or more or data 226, 228, 230, 232, and 234, etc.), further operations can be performed on the data (e.g., such as storage, retention, organization, aging, weighting, and so on, etc.) based on the one or more attributes, the one or more intervals, and/or the one or more policies, etc. As an example, FIG. 2 depicts a non-limiting organization for data in the data collection (e.g., one or more or data 226, 228, 230, 232, and 234, etc.). For instance, based on the one or more attributes, the one or more intervals, and/or the one or more policies, and so on, etc., data 228 received by computing system 202 can be organized, based on a one or more of a policy, an interval, and/or an attribute, and so on associated with or assigned to data 228, such that it is retained in destination 220.

Thus, exemplary systems and methods can facilitate handling attributes and intervals of big data, to prevent loss of structure in a collection of data that can decrease the utility of the collection due to the passage of time. In a non-limiting aspect, the various methods and systems, or portions thereof, can be built into data management products such as SQL Server®, data warehousing products, services such as cloud computing, Windows® Azure™, and so on.

### Handling Attributes and Intervals of Big Data

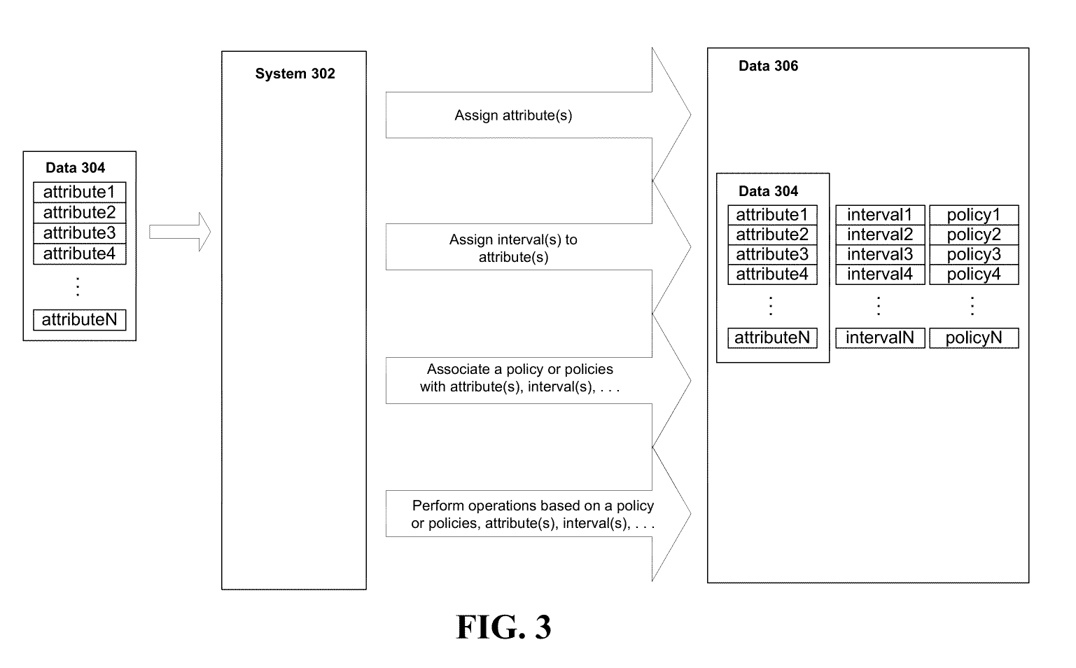

FIG. 3 is a block diagram illustrating exemplary systems 302 according to various embodiments. For instance, exemplary systems 302 can comprise one or more computing systems such as that described above regarding one or more computing systems 202, 204 (e.g., one or more computing systems 202, 204, portions thereof, etc.). Exemplary systems 302 can be configured to receive data 304, which can comprise data, such as that described above regarding data in a data collection (e.g., such as one or more or data 226, 228, 230, 232, and 234, etc.), and can be configured to analyze and/or interpret the data in the data collection comprising information, about which various attributes can be determined based on the analysis and/or interpretation. Note that, as described above, data 304, prior to being received by exemplary systems 302, can comprise one or more unknown or unassociated attributes that can be determined and/or assigned or associated with the data after receipt by exemplary systems 302, as described above regarding FIG. 2.

For instance, data 304 can comprise attributes such as a timestamp from another system and other attributes such as a time interval and validity interval as assigned in temporal databases as described above. However, exemplary systems 302 can be configured to determine and/or assign or associate with the data one or more unknown or unassociated additional attributes after receipt by exemplary systems 302, such as temporal or other information (e.g., spatial information and/or other qualities such as version, source, destination, one or more potential uses or analyses intended, probability or fact of a causal relation to another item or set of the data collection, etc.) about the data. In the non-limiting example above, an attribute concerning spatial information can be determined and/or assigned or associated with the data after receipt by exemplary systems 302.

In addition, exemplary systems 302 can be configured to determine and/or assign or associate with the data one or more unknown or unassociated additional attributes after receipt by exemplary systems 302, such as temporal or other information (e.g., spatial information and/or other qualities such as version, source, destination, one or more potential uses or analyses intended, probability or fact of a causal relation to another item or set of the data collection, etc.) about the data. In addition exemplary systems 302 can be further configured to dynamically compute and/or assign an interval to the data based on the analysis or interpretation. For example, recognizing the various attributes related to the data, exemplary systems 302 can be configured to compute one or more intervals related to the attribute or attributes.

As a further example, exemplary systems 302 can dynamically compute and/or assign a temporal interval based on temporal and/or other information (e.g., spatial information and/or other qualities such as version, source, destination, one or more potential uses or analyses intended, probability or fact of a causal relation to another item or set of the data collection, etc.) about the data. As a further example, attributes concerning spatial information or other information related to the data, such as probability or fact of a causal relation to another item or set of the data collection or one or more potential uses or analyses intended for the data, can be employed by exemplary systems 302 to facilitate dynamically computing and/or assigning one or more intervals related to the attribute or attributes.

Exemplary systems 302 can be further configured to determine, create, and/or associate one or more policies related to one or more intervals and/or attributes with the data. In a non-limiting embodiment, exemplary systems 302 can facilitate attaching significance to data (e.g., policies associated with attributes and/or intervals that allow data in the past or a different location to be lower ranked based upon personal preferences, the specification of a personal ranking system, weighting of historical data, etc.), which can facilitate weighting data so it can become less relevant to subsequent analyses, and so on. In a further non-limiting example, various embodiments can enable the attachment of temporal significance to data to facilitate weighting historical data as it ages so it can become less relevant to the query results, and so on. In yet other non-limiting embodiments, policies related to one or more intervals and/or attributes with the data can be employed by exemplary systems 302 to facilitate data organization, data retention, data collocation, creating indices, creating statistical or other summaries, and so on, etc.

For instance, in still further non-limiting embodiments, exemplary systems 302 can be configured to perform various operations on data including further analyses, interpretation, and inference, determining relationships between data such as possibility, probability, causality, and so on, assigning further intervals, creating and associating further policies, data organization, data retention, data collocation, creating indices, creating statistical or other summaries, and so on, etc., by employing data attributes, interval, and/or policies. Thus, FIG. 3 depicts data 306 comprising data 304 as well as any attributes that are determined and/or assigned or associated with data 304, any computed and/or assigned intervals, and/or determined, created, and/or associated policies related to intervals and/or attributes.

Note that while FIG. 3 depicts data 306 as comprising a one to one correlation between attributes, intervals and policies (e.g., each attribute shown with a corresponding interval and policy), the subject application is not so limited. For instance, it can be understood that an interval can concern more than one attribute (e.g., such as in an exemplary case of a validity interval related to both space and time attributes). In a further example, policies can concern more than one attribute and or interval and any combination. Thus, exemplary systems 302 can flexibly and dynamically analyze data, attributes, and intervals, can create policies, and can facilitate performing unstructured operations and analyses thereon, whereas conventional systems such as vector clocks and temporal databases would be limited by their inherent rigid structural specifications.

As a result data 304 received by exemplary systems 302 can be enriched according to various aspects of the subject application to facilitate dynamically creating insights into data and relationships therein, perform stream analysis, perform root cause analysis, generate trust-based results, data organization, aging, and retention, creating inferences from big data streams, and so on. Further note that while data 306 is depicted as comprising data 302 and corresponding attributes, intervals, and policies, various embodiments of the subject application are not so limited. In other words, further non-limiting embodiments can associate attributes, intervals, policies, and so on by appending such information into the data or otherwise (e.g., tracking by means of a file system, database system, etc.).

As a non-limiting example, in a social networking analysis regarding data concerning a user's friends, a user can be interested in updates that have happened recently. However, updates that are relatively old data are typically treated with the same priority as regards storage and retention as the new updates (e.g., only the presentation aspects of new data are given priority). In a further non-limiting example regarding analysis and correlation of financial stock trends, the user can be interested in recent developments and updates concerning a stock, to the exclusion of developments more remote in time. For example, while a historical Form 10-K annual report for a company is conventionally disregarded in the presentation of stock price data, recent news developments concerning litigation against the company, can restore relevance of the historical 10-K in the analysis of stock price data trends. As a further illustration, flat representation of temporal attributes would typically treat the historical Form 10-K data as a file perhaps having a timestamp, and which may even have a conventional temporal interval associated with it of one year or one quarter (e.g., until the next update). However, it is clear that litigation attributes of the data (e.g., parties and subject of the litigation, type of litigation, etc.) can have a longer event horizon, and thus a longer temporal significance or relevance than simple financial attributes of the historical Form 10-K data. In addition, data concerning a recent news story that names the same parties, subject of the litigation, or type of litigation can be causally connected or of great relevance to and/or change the significance of the historical Form 10-K data in the context of reviewing stock price trend data. Accordingly, various embodiments of subject application facilitate accounting for such disparate and changing significance of different attributes and enable the creation of policies for various functions (e.g., collocating data, creating indices over data, aging the impact of data out of the data collection, and so on, etc.) that conventional systems have heretofore failed to consider.

In a further example, various embodiments can facilitate aging the impact of data of the data collection completely, such as in removing data from the collection on an in or out basis, using intervals as a weighting factor, and/or an action based on a more sophisticated analysis or inference (e.g., actions based on a Bayesian probability, etc.). For instance, exemplary systems 302 can employ an interval such as a temporal interval as a partitioning strategy (e.g., locating particular data or events on a particular system or storage disk among a series of systems or storage disks associated with a particular use, analysis, reasoning or inference operation, etc. related to the temporal interval) or as a maintenance strategy (e.g., aging data or events of a particular data collection the temporal interval, etc.).

In yet another non-limiting example, in determining whether events are causally related versus merely correlated, exemplary systems can employ intervals such as temporal intervals to determine the possibility of causal relationships, correlations, and so on. For instance, for two pieces of data or events occurring sequentially in time, e.g., a precedent and an antecedent, the precedent and antecedent can be correlated or uncorrelated. In addition, the precedent can be causally related to the antecedent (e.g., the precedent is the cause of the antecedent), but the antecedent cannot be the cause of the precedent, because the precedent occurs prior in time, or prior in the temporal interval than the antecedent. Accordingly, in various non-limiting embodiments, exemplary systems can employ intervals such as temporal intervals to determine causal relationships in addition to correlations, and so on, as described herein. In a similar manner regarding physical proximity of data or events in space, two pieces of data or events occurring sequentially in time may be precluded from having a causal relationship due to a lack of physical proximity. Thus, the subject application can advantageously facilitate distinguishing between causal relationships and correlations as described above.

In a non-limiting of exemplary embodiments, attributes and intervals regarding temporal can employ a simple linear ordering in time such that vector clock systems can be used, such that inferences can be made from this vector clock time not rather than absolute clock time or some similar notion such as system clock time. In other exemplary embodiments other notions of time can be employed, such as relative time based on a sequence of events (e.g., treating data as a sequence of events that can be causally related), GPS clock time, etc. In addition, such notions of time can be employed to create inferences such as Bayesian inferences to update uncertainty associated with data (and predictions or inferences) in a probability model, according to a further non-limiting aspect.

Thus, in non-limiting embodiments, exemplary systems 302 can dynamically generate or learn temporal intervals (e.g., as the data or events come into the system, etc.) of relevance for data or events, for such purposes as determining causality as described above. It can be understood that time data, such as timestamps, like spatial data, such as GPS coordinates, are generally considered fixed values or hard values that are relatively absolute in relation to associated data or events. However, temporal intervals of relevance can be highly dependent upon a number of factors. As a further illustration, temporal intervals of relevance can be dependent upon non-limiting factors including usage or intended usage of the data or event, the user or users of the data or event, the environment of the data or event (e.g., geospatial location of the data or event), etc.

In other non-limiting embodiments, exemplary systems 302 can generate or learn temporal intervals for causality purposes over time. Thus, in various embodiments, for an event or data, rather than simply being time stamped when it came into the system, exemplary systems can dynamically determine (e.g., via a temporal Bayesian network, etc.) temporal intervals such as how long to remember that the data or event holds (e.g., the probability of the data or event remaining true, remains in adherence to a temporal interval based policy, etc.) based on the type of analysis. For example, as described above, an observation or analysis related to data or events can become less precise overtime, such that the desire for retention or inclusion of the data or event related to the observation or analysis becomes less desirable.

In addition, as further described above, different attributes of the data or events can have different timelines over which the attributes age (e.g., the significance of the attribute or associated data become less relevant over time compared to other attributes or data). Thus, in further non-limiting embodiments, exemplary systems can employ the dynamically determined temporal intervals for other purposes such as (e.g., data organization, reorganization, and/or retention on size limited devices or components such as disk storage, memory, etc.) as further described herein. Accordingly, exemplary systems 302 can automatically tune themselves to remember data or events and/or attributes, intervals, and/or policies for a predetermined period of time (e.g., according to a temporal interval based policy, according to intended, predetermined, and/or inferred prospective uses or analyses, according to determined and/or inferred relationships with other data or events, etc.).

For example, consider the assertions, “I have cancer,” “I have a new car,” and so on as events. These two events are very different with very different implications in terms of their temporal relevance for a user's state, for his or her future state, and for analysis at any particular point in time. In a further example, stock price data and other events coming into an automated system (e.g., press releases, earnings reports, Form 10-Ks, court decisions, etc.) and as a function of exemplary system 302 automatically assigning temporal intervals to those data or events, the data or events could be maintained for retention purposes, for analysis purposes, for structural organization of data (e.g., such as paging data off to cold servers based on the age of the data or its relevance for reasoning and analysis, etc.), making summaries, running aggregates, or doing pre-computation to remember the data in low fidelity based on time (e.g., data or events further back in time the can be summarized providing a less accurate or granular representation thereby limiting storage requirements, etc.).

In a data cache example, exemplary systems can employ policies that employ temporal intervals to facilitate cache management. As a non-limiting example, even though particular data or events may be relatively old as identified by the associated temporal intervals, if there are frequent queries based on the particular data or events (e.g., such as frequent queries of the date of a person's birthday, etc.), the particular data or events can be retained in the cache according to cache management policies related to the associated temporal intervals. Thus, in various non-limiting embodiments, exemplary systems can recognize such usage as an attribute of the data (e.g., such as frequent queries of the date of a person's birthday, etc.) and modify or update the associated temporal intervals associated with the data or events (e.g., increasing the associated temporal intervals, etc.).

In further non-limiting embodiments, exemplary systems can dynamically generate temporal intervals based on one or more of the recognized usage of the particular data or events or the modification or updates made in recognition of the usage for similar types of future data or events. That is, once a an interval for data or an event is updated based on a usage attribute, exemplary systems can infer that such attributes apply to similar data and apply the intervals to such similar data in the future (or for such similar classes of data already received). Thus, in a non-limiting example, dynamically generated temporal intervals for future data or events can be retained longer in the cache in accordance with cache management policies, which would keep the data or events close for easy access, boost confidence in the temporal interval associated with the data or events, and so on.

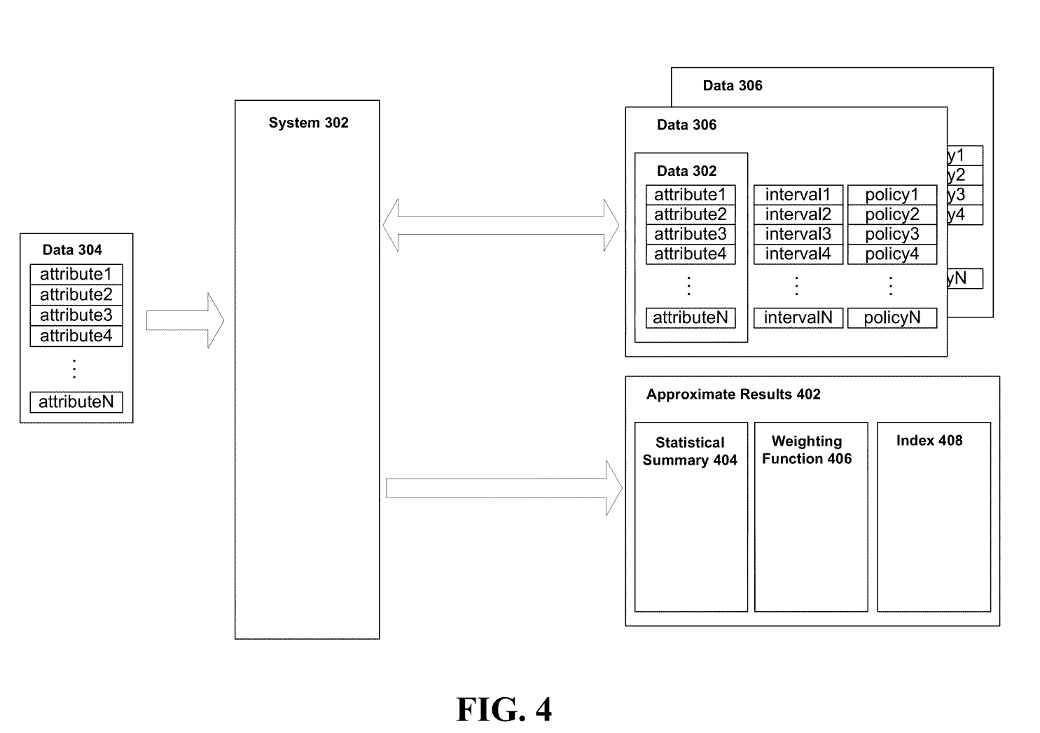

In still further non-limiting examples, systems 302 can facilitate generating approximate results, creating statistical descriptions or summaries of data, informing the sampling of data in a data collection, adding weighting functions to data, down-weighting of aged data, and so on, in the handling of big data, etc. For example, FIG. 4 is a block diagram illustrating exemplary systems 302, according to further non-limiting aspects. For instance, exemplary systems 302 can be configured to generate approximate results 402 over data (e.g., collections of data 306, with or without further data considered, etc.), such as one or more statistical descriptions or statistical summaries 404, where detail of the statistical summaries 404 can depend on the age of the data or events. Statistical summaries 404 or descriptions can further comprise automatically composed averages or summaries of a set of data or events from a collection of data or events (e.g., including collections of data 306, with or without further data considered, etc.), for instance, by accounting for data age, so that future queries of the collection of data or events for each successive use of the set of data or events are obviated.

As a further example, for a collection having 10 years worth of data or events, a particular use, analysis, or query might be relatively more applicable to the data or events pertaining to the last week than is applicable to data or events from several years ago. Thus, exemplary systems 302 can provide one or more approximate results 402 of data or events, including the relatively older data or events (e.g., statistical summaries 404, sampling recommendations, averages, and so on, etc.), that can be employed based on one or more intended uses (e.g., queries, analyses, etc.) to provide results of a particular fidelity (e.g., within a given error, within a given confidence level, etc.).

In addition, approximate results 402 can further comprise weighting functions 406 associated with or related to data or events (e.g., such as temporal weighting functions derived from a policy on data retention and/or aging of data, or other weighting functions). As a result, exemplary systems 302 can be weighted based on the age of the data or events. As a non-limiting example, relatively older data or events can be down-weighted relative to newer data or events, as well as applying other weighting schemes. As a result, such approximate results can inform the sampling of data in a data collection for future uses of the data in the data collection, for example, by down-weighting of aged data. For example, if a particular use intends that data or events older than a year are down-weighted by a factor of 100 according to a weighting function 406, such as a temporal weighting function, then it can be expected that you can have much larger error in relatively older data or events.

Moreover, the further back data or an event is in time, the lower the confidence of its interval. That is, for a given use or analysis of data or an event, the interval of the data or event may no longer be valid. Accordingly, based on a temporal interval, it can be reasoned that the data or event associated with a temporal interval is no longer accurate, such that the data or event can be organized or retained based on the confidence of its temporal interval. For example, rather than retaining a number of individual data points or events (e.g., 10,000 individual salaries, etc.) for a given use, the individual data points or events can be grouped, organized, and/or retained based on the associated temporal intervals or the respective confidence of the associated temporal intervals (e.g., replacing the retained data or events for the 10,000 individual salaries with an aggregated value or representation, etc.). Thus, one or more summaries of data or events of the relatively older data or events can be employed, recognizing the associated larger error, according to a further non-limiting aspect, to efficiently provide results of a particular fidelity. Accordingly, further non-limiting implementations of exemplary systems can employ temporal weighting functions to facilitate efficiently providing results of a particular fidelity.

While the foregoing describes confidence in data or intervals in terms of temporal intervals, similar discussions apply concerning other attributes or information (e.g., location information, information concerning source of data, information concerning prospective uses or analyses, etc.). In a non-limiting example, for location-based data or events (e.g., having a location attribute), it can be understood that as the data or event ages, confidence in the location will deteriorate, especially in a highly mobile and connected society generating large amounts of new data by the minute. However, as a subsequent location-based data or event enters into consideration, confidence in earlier location-based data or events can be improved, remain the same, or decrease.

As a result, location-based data can “age” (e.g., become more or less reliable) somewhat independent of time. For example, for a series of measurements about the location of an object (e.g., a user's mobile device, a location of a credit card transaction, a source of a network event, etc.), between subsequent measurements, confidence in the measurement can decrease (e.g., as the data or events related to the measurements age), simply because of the passage of time, until another measurement is taken into consideration. Thus, in a sense, an interval associated with a location attribute, as it ages, can be increasing over time (e.g., the object about which the location attribute pertains may have moved), but with decreasing confidence in the attribute. Thus, for a given use, the confidence can be expected to decrease for that interval until the location-based data or attribute is updated. It is noted that, while the above assumes that the initial location-based data is simply updated with a new location-based data point, it can also be that, based on inferences made by exemplary systems 302, a location attribute is updated for the location-based data due to understanding of relations with other data 306 or data 302.

The same applies to discussions of attributes relating to source of data (e.g., data source, number of sources, number of sources that affirm or disaffirm an inference, etc.) within the discussion of confidence in data or intervals. An initial data point of data 302 or data 306 can have a source attribute and can have an interval associated with it. Confidence in that data can depend on an initially presumed reliability. Confidence in the data, source attribute, and/or interval can depend on such things as the passage of time (e.g., firms go out of business, people switch cell phones, URLs (uniform resource locators) can change, etc.). In addition, further data from new sources can reaffirm or disaffirm data, the relative numbers of which can impact, not only confidence in the data itself, but also inferences drawn therefrom, source attributes of the initial data point, intervals, and confidence therein. Thus, if there are many affirming data sources, it may be desired to unequally weight data from a particular source to accomplish data organization, data retention, data analysis, and so on. Thus, various embodiments of the subject application can employ weighting functions 406 to facilitate weighting of data (e.g., down-weighting of aged data, etc.) according to various considerations, data, attributes, interval, etc.

In further non-limiting examples, approximate results 402 can comprise a sophisticated index 408 (or multiple indices or summaries) generated by exemplary systems 302 to facilitate more efficient queries of the collection of data or events (e.g., based on knowledge of the weighting functions, attributes, intervals, and/or policies). For example, exemplary systems 302, having knowledge of a particular storage or retention policy or intended analyses concerning particular data 306, can provide indices that specifically include or exclude such data 306 (e.g., substituting statistical summaries 404, etc.) based on knowledge exemplary systems 302 gain from interacting with the data collection (e.g., knowledge that data 306 is not readily available as it has been aged out of the system, data 306 is no longer valid or not reliable for an intended purpose, etc.).

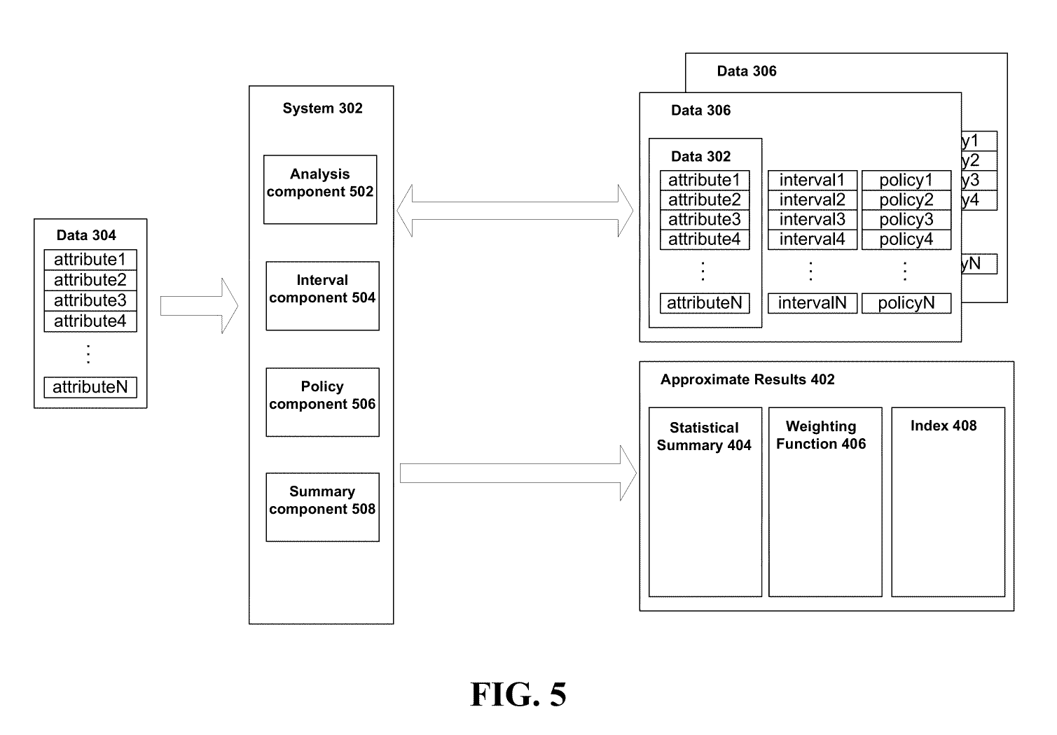

FIG. 5 is a block diagram illustrating exemplary systems, according to further non-limiting aspects. For example, FIG. 5 depicts exemplary systems 302 as previously described. In a non-limiting embodiment, exemplary systems 302 can comprise a computing device, such as further described herein, comprising a memory having computer executable components stored thereon, and a processor communicatively coupled to the memory, wherein the processor is configured to facilitate execution of the computer executable components. Thus, exemplary systems 302 can comprise computer executable components such as an analysis component 502, an interval component 504, a policy component 506, and/or a summary component 508, or portions thereof, as well as further executable components configured to provide functions as described herein.

As a non-limiting example, analysis component 502 can be configured to interpret data received by the computing device to determine one or more previously undetermined or unknown attributes of the data (e.g., as described above regarding FIGS. 2-3, etc.) to create one or more attributes of the data. In addition, analysis component 502 can be further configured to determine a causal relation as described herein to other data as a second attribute associated with the data based in part on the one or more attributes. In a further non-limiting example, Interval component 504 can be configured to assign one or more intervals to the one or more attributes based on the one or more attributes of the data and the second attribute associated with the data.

In yet another non-limiting example, policy component 506 can be configured to associate a policy related with the one or more attributes or the interval to facilitate management of the data. For example, a policy can a data aging policy, a data retention policy, a data organization policy, a data ranking policy, a policy of weighting of historical data according to the weighting function, as well as other policies as described herein. In addition, summary component 508 can generate an approximate result, as further described herein, concerning the data based on one or more attributes or the interval and the policy. For instance, as described herein, the approximate result can include a summary of the data, a weighting function concerning the data, or an index concerning the data.

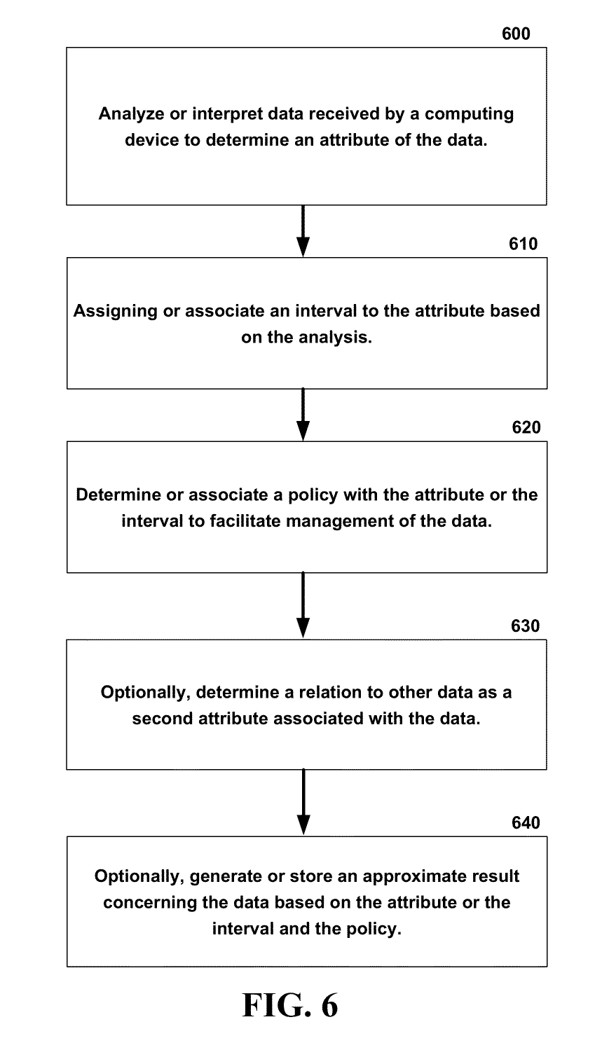

FIG. 6 is a flow diagram illustrating a non-limiting process for data management in an embodiment. For example, at 600, data received by a computing device to is analyzed or interpreted to determine one or more attributes of the data. For example, the one or more attributes of the data can include previously unknown or undetermined attributes of the data, as described above. At 610, an interval is assigned to or associated with the one or more attributes based on the analysis. As described above, an interval can be computed as a temporal interval associated with one or more attributes of the data, and the one or more attributes of the data can include a temporal attribute, a spatial attribute, a version attribute, a network location, an Internet Protocol address, a source of the data, a destination of the data, a relation to other data, or a prospective use of the data, as well as other attributes described herein.

At 620, a policy is determined and/or associated with the one or more attributes or the interval to facilitate management of the data. For example, a policy can include a data aging policy, a data retention policy, a data organization policy, a data ranking policy among other above-described policies. As a further example, a data ranking policy can include a personal ranking system, whereas a data aging policy can include a policy of weighting of historical data according to a weighting function, and so on. Optionally, at 630, a relation to other data is determined as a second attribute associated with the data. As a further option, at 640, an approximate result concerning the data, based on the one or more attributes or the interval and the policy, is generated and/or stored. For instance, as described herein, an approximate result can include a summary of the data, a weighting function concerning the data, or an index concerning the data

### Exemplary Networked and Distributed Environments

One of ordinary skill in the art can appreciate that the various embodiments for data management described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the mechanisms for data management as described for various embodiments of the subject disclosure.

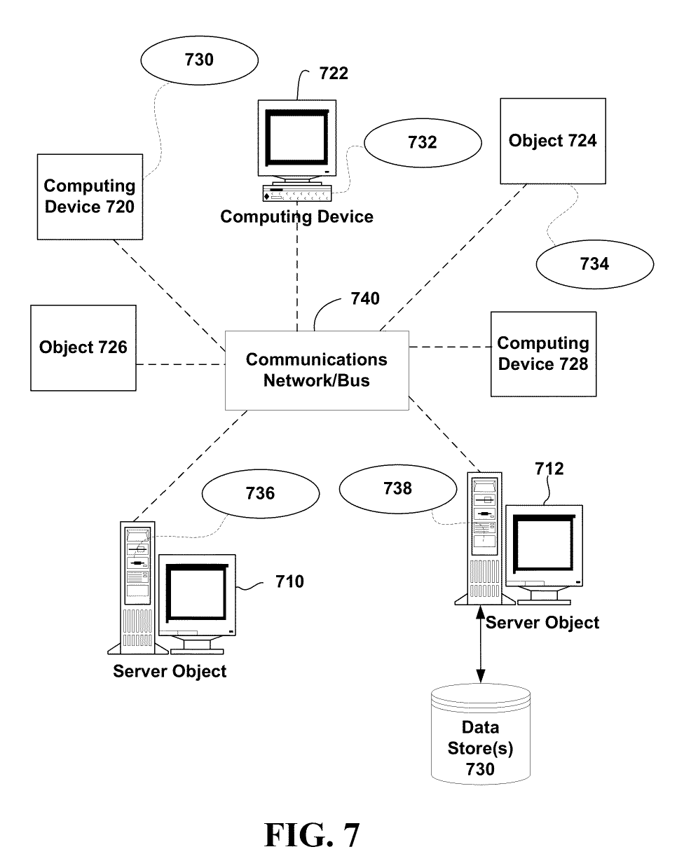

FIG. 7 provides a schematic diagram of an exemplary networked or distributed computing environment. The distributed computing environment comprises computing objects 710, 712, etc. and computing objects or devices 720, 722, 724, 726, 728, etc., which may include programs, methods, data stores, programmable logic, etc., as represented by applications 730, 732, 734, 736, 738 and data store(s) 740. It can be appreciated that computing objects 710, 712, etc. and computing objects or devices 720, 722, 724, 726, 728, etc. may comprise different devices, such as personal digital assistants (PDAs), audio/video devices, mobile phones, MP3 players, personal computers, laptops, etc.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 742, either directly or indirectly. Even though illustrated as a single element in FIG. 7, communications network 742 may comprise other computing objects and computing devices that provide services to the system of FIG. 7, and/or may represent multiple interconnected networks, which are not shown. Each computing object 710, 712, etc. or computing object or devices 720, 722, 724, 726, 728, etc. can also contain an application, such as applications 730, 732, 734, 736, 738, that might make use of an API, or other object, software, firmware and/or hardware, suitable for communication with or implementation of the techniques for data management provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for data management as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc., acting as servers provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 742 or bus is the Internet, for example, the computing objects 710, 712, etc. can be Web servers with which other computing objects or devices 720, 722, 724, 726, 728, etc. communicate via any of a number of known protocols, such as the hypertext transfer protocol (HTTP). Computing objects 710, 712, etc. acting as servers may also serve as clients, e.g., computing objects or devices 720, 722, 724, 726, 728, etc., as may be characteristic of a distributed computing environment.

### Exemplary Computing Device

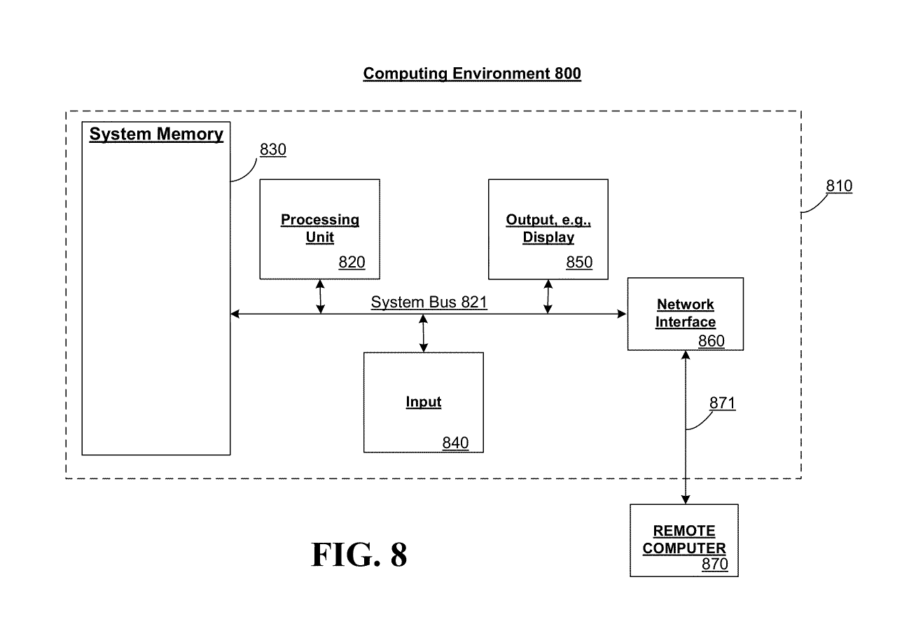

As mentioned, advantageously, the techniques described herein can be applied to any device where it is desirable to perform data management in a computing system. It can be understood, therefore, that handheld, portable and other computing devices and computing objects of all kinds are contemplated for use in connection with the various embodiments, i.e., anywhere that resource usage of a device may be desirably optimized. Accordingly, the below general purpose remote computer described below in FIG. 8 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. Neither should the computing system environment 800 be interpreted as having any dependency or requirement relating to any one or combination of components illustrated in the exemplary computing system environment 800.

With reference to FIG. 8, an exemplary remote device for implementing one or more embodiments includes a general purpose computing device in the form of a computer 810. Components of computer 810 may include, but are not limited to, a processing unit 820, a system memory 830, and a system bus 822 that couples various system components including the system memory to the processing unit 820.

Computer 810 typically includes a variety of computer readable media and can be any available media that can be accessed by computer 810. The system memory 830 may include computer storage media in the form of volatile and/or nonvolatile memory such as read only memory (ROM) and/or random access memory (RAM). By way of example, and not limitation, system memory 830 may also include an operating system, application programs, other program modules, and program data. According to a further example, computer 810 can also include a variety of other media (not shown), which can include, without limitation, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information.

A user can enter commands and information into the computer 810 through input devices 840. A monitor or other type of display device is also connected to the system bus 822 via an interface, such as output interface 850. In addition to a monitor, computers can also include other peripheral output devices such as speakers and a printer, which may be connected through output interface 850.

The computer 810 may operate in a networked or distributed environment using logical connections, such as network interfaces 860, to one or more other remote computers, such as remote computer 870. The remote computer 870 may be a personal computer, a server, a router, a network PC, a peer device or other common network node, or any other remote media consumption or transmission device, and may include any or all of the elements described above relative to the computer 810. The logical connections depicted in FIG. 8 include a network 872, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system.

In addition, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

1. A data management method, comprising:
analyzing data received by a computing device to determine at least one attribute of the data;
assigning an interval to the at least one attribute based on the analyzing; and
associating a policy with at least one of the at least one attribute or the interval to facilitate management of the data.

2. The method of claim 1, the assigning the interval includes computing a temporal interval associated with the at least one attribute, wherein the at least one attribute comprises at least one of a temporal attribute, a spatial attribute, a version attribute, a network location, an Internet Protocol address, a source of the data, a destination of the data, a relation to other data, or a prospective use of the data.

3. The method of claim 2, wherein the computing includes computing the temporal interval based on a second attribute associated with the data.

4. The method of claim 3, further comprising: determining the relation to other data as the second attribute associated with the data.

5. The method of claim 1, wherein the associating the policy includes associating at least one of a data aging policy, a data retention policy, a data organization policy, or a data ranking policy with the at least one of the at least one attribute or the interval.

6. The method of claim 6, wherein the associating the data ranking policy includes associating a personal ranking system and the associating the data aging policy includes associating a policy of weighting of historical data according to a weighting function.

7. The method of claim 6, further comprising:
generating an approximate result concerning the data based in part on at least one of the at least one attribute or the interval and the policy.

8. The method of claim 7, wherein the generating includes generating the weighting function.

9. The method of claim 7, wherein the generating includes generating an index concerning the data based on the at least one of the at least one attribute or the interval and the policy.

10. A computing device, comprising:
a memory having computer executable components stored thereon; and
a processor communicatively coupled to the memory, the processor configured to facilitate execution of the computer executable components, the computer executable components comprising:
an analysis component configured to interpret data received by the computing device to determine at least one previously undetermined attribute of the data to create at least one attribute of the data;
an interval component configured to assign an interval to the at least one attribute based on the at least one attribute of the data and a second attribute associated with the data; and
a policy component configured to associate a policy with at least one of the at least one attribute or the interval to facilitate management of the data.

11. The computing device of claim 10, wherein the analysis component is further configured to determine a causal relation to other data as the second attribute associated with the data based in part on the at least one attribute.

12. The computing device of claim 10, further comprising:
a summary component that generates an approximate result concerning the data based in part on at least one of the at least one attribute or the interval and the policy.

13. The computing device of claim 12, wherein the approximate result comprises at least one of a summary of the data, a weighting function concerning the data, or an index concerning the data.

14. The computing device of claim 13, wherein the policy comprises at least one of a data aging policy, a data retention policy, a data organization policy, a data ranking policy, a policy of weighting of historical data according to the weighting function.

15. A computer-readable storage device comprising computer-readable instructions that, in response to execution, cause a computing device to perform operations, comprising:
interpreting data received by the computing device to determine at least one previously unknown attribute of the data to create at least one attribute of the data;
associating an interval to the at least one attribute based on the interpreting; and
determining a policy related to at least one of the at least one attribute or the interval to facilitate management of the data.

16. The computer-readable storage device of claim 15, wherein the associating the interval includes computing a temporal interval associated with the at least one attribute and a second attribute associated with the data including at least one of a spatial attribute, a version attribute, a network location, an Internet Protocol address, a source of the data, a destination of the data, a relation to other data, or a prospective use of the data.

17. The computer-readable storage device of claim 16, the operations further comprising:
determining the relation to other data as the second attribute associated with the data.

18. The computer-readable storage device of claim 15, wherein the determining the policy includes determining at least one of a data aging policy, a data retention policy, a data organization policy, a policy of weighting of historical data, or a data ranking policy with at least one of the at least one attribute or the interval, and includes associating the policy with the at least one of the at least one attribute or the interval.

19. The computer-readable storage device of claim 15, the operations further comprising:
storing an approximate result concerning the data based in part on at least one of the at least one attribute or the interval and the policy.

20. The computer-readable storage device of claim 19, wherein the storing includes storing at least one of a summary of the data or an index concerning the data.
